(19) United States
(12) Patent Application Publication
(10) Pub. No.: US 2019/0371043 A1
(43) Pub. Date: Dec. 5, 2019

(54) METHOD AND SYSTEM FOR SMOOTH LEVEL OF DETAIL INTERPOLATION FOR PARTIALLY RESIDENT TEXTURES

(71) Applicant: Advanced Micro Devices, Inc., Santa Clara, CA (US)

(72) Inventor: Maxim V. Kazakov, La Jolla, CA (US)

(73) Assignee: Advanced Micro Devices, Inc., Santa Clara, CA (US)

(21) Appl. No.: 15/992,237

(22) Filed: May 30, 2018

(51) Int. Cl. G06T 15/04; G06T 17/10; G06T 11/40; G06T 15/00

(52) U.S. Cl. CPC G06T 15/04; G06T 17/10; G06T 2210/36; G06T 15/005; G06T 11/40

(57) ABSTRACT

A modified bilinear filter and method for use in a texture processor system are described herein. The system includes a texture processor, which includes a texture address unit and a texture data unit. The texture data unit includes a bilinear filter. An application sends a texture instruction which is processed by a texture address unit to obtain at least a level of detail (LOD) map and texel data. The texture data unit generates modified texel inputs from the LOD map texel data and at least two weights in a texture space region. The bilinear filter applies the at least two weights to the modified texel inputs, where the modified texel inputs and weights prevent finer LOD values from leaking into an area of coarser LOD values.

### BACKGROUND

Texture mapping refers to a method for adding detail, surface texture, or color to a computer-generated graphic or three-dimensional model. When rendering computer-generated graphics, one or more textures can be applied (or mapped) to each geometric primitive of the graphic. These textures contain, for example, color and luminance data to be mapped to each of the geometric primitives. A challenge in texture mapping, among others, is the storage and management of textures and associated MIPs or mipmaps. MIPs are pre-calculated, optimized collections of images that accompany a texture in video memory, each of which is a progressively lower resolution representation of the same image. Partially resident textures (PRT) provide a method for handling textures too large for the graphics memory. Sampling of non-resident portions of a PRT resource returns black color using conventional sampling techniques.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. A more detailed understanding can be had from the following description, given by way of example in conjunction with the accompanying drawings wherein:

FIG. 1 illustrates an example level of detail (LOD) or residency map;

FIG. 2 illustrates an LOD map sampling example;

FIGS. 3A and 3B illustrate leakage issue with respect to bilinear filtering and LOD maps;

FIGS. 3A and 3C illustrate resolving the leakage issue using modified texel inputs and weights in accordance with certain implementations;

FIG. 4 is a block diagram of an example device in accordance with certain implementations;

FIG. 5 is a block diagram of the device of FIG. 4, illustrating additional detail in accordance with certain implementations;

FIG. 6 is a high level block diagram of an example texture processor system in accordance with certain implementations;

FIG. 7 is a more detailed block diagram of an example texture processor system in accordance with certain implementations;

FIG. 8 is a diagram illustrating generation of modified texel inputs in accordance with certain implementations;

FIG. 9 is a diagram illustrating generation of U coordinate weights (weight_u) in accordance with certain implementations; and

FIG. 10 is a flowchart for a method for preventing finer result value leakage into areas of coarser result values in accordance with certain implementations.

### DETAILED DESCRIPTION

Partially Resident Textures (PRTs) are textures that have only portions of the texture stored in memory. PRTs enable applications to manage more texture data than can physically fit in a fixed footprint. A current render view may only require selected portions of the texture and selected MIP levels to be resident in memory at a given time. Existing techniques for sampling non-resident portions of a PRT resource return black color.

Improvements in non-resident areas sampling behavior require an application to provide a level of detail (LOD) map indicating the finest MIP level populated for or in a PRT resource per a UV texture space region. The LOD map is sampled first to provide per-pixel finest populated MIP Level over all UV texture space regions sampled for the pixel. The result of sampling the LOD map is used to clamp LOD when sampling an actual PRT resource to restrict sampling to populated MIP levels only.

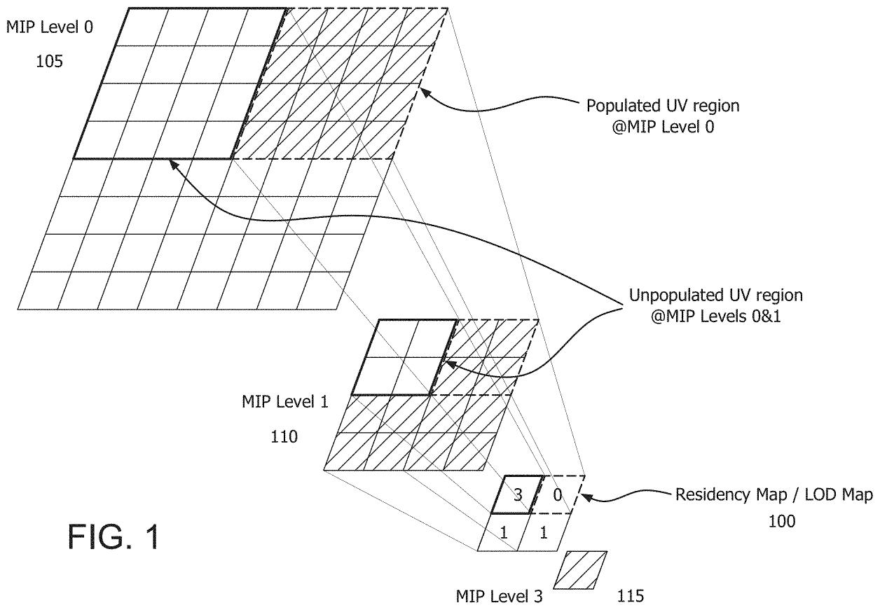

FIG. 1 illustrates an example LOD or residency map 100 and associated MIP levels 105, 110 and 115. The LOD map 100 is a single plane (no other MIP levels) as it specifies an LOD value per UV region shared by all MIP levels of the PRT resource. The LOD map 100 has dimensions that are smaller than the finest MIP level. For example, the LOD map 100 is smaller than MIP level 0 105, which is the finest MIP level in FIG. 1. The LOD map texels specify LOD value per element of evenly divided normalized UV texture space, where a texel represents a unit in texture space. The value has equal or bigger (coarser) LOD values than an index of finest populated MIP level for the corresponding UV region and all coarser MIP levels must have the same UV region populated. For example, for an LOD map texel containing value of 0 all MIP levels from MIP level 0 105 to the coarsest MIP level, i.e. MIP level 3 115 must be populated for a corresponding UV space region.

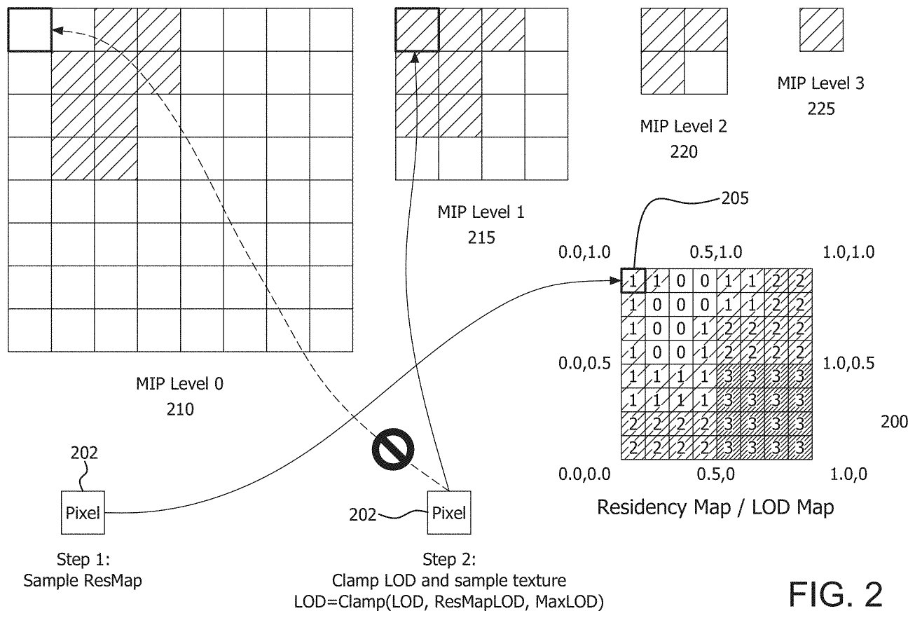

FIG. 2 illustrates an LOD map sampling example. An LOD map 200 is sampled for a given pixel 202 (step 1). An LOD clamp value for the pixel's UV coordinates is determined based on finest populated MIP level (step 2). For the pixel 202, all texture samples are corresponding to a UV area that is mapped to the texel 205 of the LOD map 200. According to the value of the texel 205, MIP level 0 210 is unpopulated, MIP level 1 215 is populated, MIP level 2 220 is populated and MIP level 3 225 is populated. Consequently, an LOD value of 1 is returned from LOD map sampling and is used for the LOD clamp as MIP level 1 215 is the finest populated MIP level. The LOD clamp is then used when sampling an actual PRT resource to restrict sampling to populated MIP levels only. That is, the LOD clamp is fed into the PRT sampling operation to restrict sampling to a resident MIP level for the pixel. This process is then repeated for each pixel sampling PRT texture.

Bilinear filtering is applied to the sampled texture value to smooth textures when displayed larger or smaller than they actually are. In particular, bilinear filtering provides smooth interpolation between texels. Application of plain or conventional bilinear filtering to the LOD value fetched from the LOD map results in hitting non-populated PRT resource areas. Existing bilinear filtering implemented in texture processor hardware cannot be directly applied to LOD map filtering as smaller (finer) LOD values leak into areas of bigger (coarser) LOD values. That is, the bilinear filtering operation returns finer LOD values than actually populated as per the LOD map.

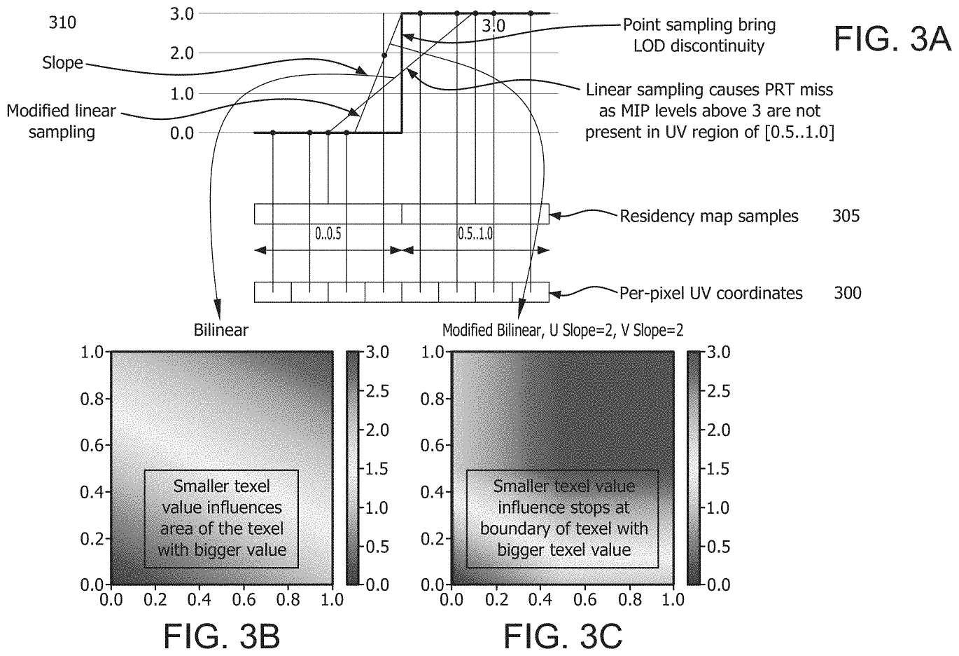

The leaking problem with respect to application of conventional bilinear filtering is illustrated in FIGS. 3A and 3B. FIG. 3A shows multiple pixel UV coordinates 300 for a number of pixels, LOD map samples 305 and for each pixel UV coordinate 300, a MIP level 310. Application of conventional bilinear filtering causes PRT misses as MIP levels above 3 are not present in the UV texture space region of [0.5-1.0]. Consequently, a texel with a small texel value influences the area of a texel with a big texel value as illustrated in FIG. 3B. That is, smaller (finer) LOD values leak into areas of bigger (coarser) LOD values as a result of applying a conventional bilinear filter and finer LOD values are returned for UV texture space regions than actually populated per LOD map.

A modified bilinear filter and method for use in a texture processor are described herein. The modified bilinear filter prevents leaking small (finer LOD) sample values into areas of bigger (coarser LOD) sample values during filtering at a small cost without performance degradation. The modified bilinear filter is a smooth interpolation filter that prevents smaller values from leaking into areas covered by LOD map texels having bigger values. In particular, texel inputs and weights are generated which prevent smaller (finer LOD) values leaking into the area of bigger (coarser LOD) values.

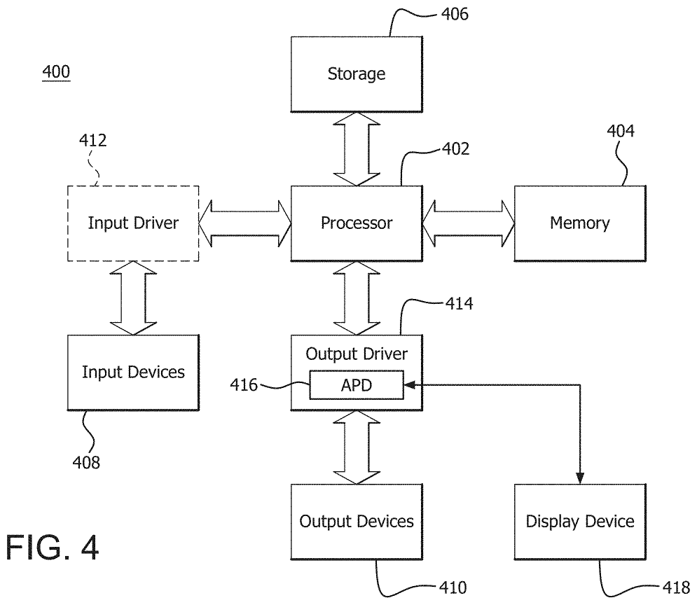

FIG. 4 is a block diagram of an example device 400 in which one or more features of the disclosure can be implemented. The device 400 can include, for example, a computer, a gaming device, a handheld device, a set-top box, a television, a mobile phone, or a tablet computer. The device 400 includes a processor 402, a memory 404, a storage 406, one or more input devices 408, and one or more output devices 410. The device 400 can also optionally include an input driver 412 and an output driver 414. It is understood that the device 400 can include additional components not shown in FIG. 4.

In various alternatives, the processor 402 includes a central processing unit (CPU), a graphics processing unit (GPU), a CPU and GPU located on the same die, or one or more processor cores, wherein each processor core can be a CPU or a GPU. In various alternatives, the memory 404 is located on the same die as the processor 402, or is located separately from the processor 402. The memory 404 includes a volatile and/or non-volatile memory, for example, random access memory (RAM), dynamic RAM, or a cache.

The storage 406 includes a fixed or removable storage, for example, a hard disk drive, a solid state drive, an optical disk, or a flash drive. The input devices 408 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 410 include, without limitation, a display, a speaker, a printer, a haptic feedback device, one or more lights, an antenna, or a network connection (e.g., a wireless local area network card for transmission and/or reception of wireless IEEE 802 signals).

The input driver 412 communicates with the processor 402 and the input devices 408, and permits the processor 402 to receive input from the input devices 408. The output driver 414 communicates with the processor 402 and the output devices 410, and permits the processor 402 to send output to the output devices 410. It is noted that the input driver 412 and the output driver 414 are optional components, and that the device 400 will operate in the same manner if the input driver 412 and the output driver 414 are not present. The output driver 416 includes an accelerated processing device (“APD”) 416 which is coupled to a display device 418. The APD is configured to accept compute commands and graphics rendering commands from processor 402, to process those compute and graphics rendering commands, and to provide pixel output to display device 418 for display. As described in further detail below, the APD 416 includes one or more parallel processing units configured to perform computations in accordance with a single-instruction-multiple-data (“SIMD”) paradigm. Thus, although various functionality is described herein as being performed by or in conjunction with the APD 416, in various alternatives, the functionality described as being performed by the APD 416 is additionally or alternatively performed by other computing devices having similar capabilities that are, in some cases, not driven by a host processor (e.g., processor 402) and in some implementations configured to provide graphical output to a display device 418. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm can perform the functionality described herein.

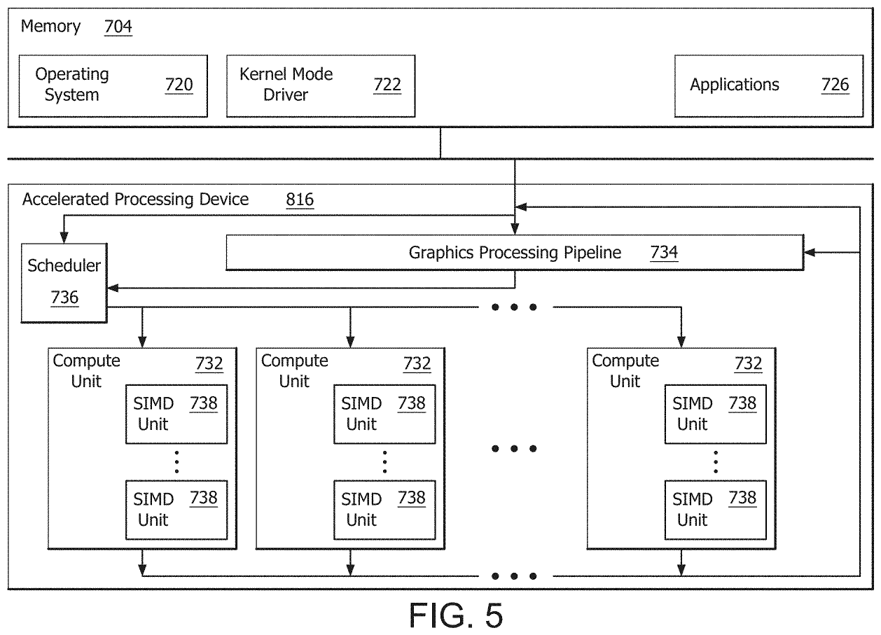

FIG. 5 is a block diagram of the device 400, illustrating additional details related to execution of processing tasks on the APD 416. The processor 402 maintains, in system memory 404, one or more control logic modules for execution by the processor 402. The control logic modules include an operating system 420, a kernel mode driver 422, and applications 426. These control logic modules control various features of the operation of the processor 402 and the APD 416. For example, the operating system 420 directly communicates with hardware and provides an interface to the hardware for other software executing on the processor 402. The kernel mode driver 422 controls operation of the APD 416 by, for example, providing an application programming interface (“API”) to software (e.g., applications 426) executing on the processor 402 to access various functionality of the APD 416. The kernel mode driver 422 also includes a just-in-time compiler that compiles programs for execution by processing components (such as the SIMD units 438 discussed in further detail below) of the APD 416.

The APD 416 executes commands and programs for selected functions, such as graphics operations and non-graphics operations that may be suited for parallel processing. The APD 416 can be used for executing graphics pipeline operations such as pixel operations, geometric computations, and rendering an image to display device 418 based on commands received from the processor 402. The APD 416 also executes compute processing operations that are not directly related to graphics operations, such as operations related to video, physics simulations, computational fluid dynamics, or other tasks, based on commands received from the processor 402.

The APD 416 includes compute units 432 that include one or more SIMD units 438 that are configured to perform operations at the request of the processor 402 in a parallel manner according to a SIMD paradigm. The SIMD paradigm is one in which multiple processing elements share a single program control flow unit and program counter and thus execute the same program but are able to execute that program with different data. In one example, each SIMD unit 438 includes sixteen lanes, where each lane executes the same instruction at the same time as the other lanes in the SIMD unit 438 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 432 is a work-item. Each work-item represents a single instantiation of a program that is to be executed in parallel in a particular lane. Work-items can be executed simultaneously as a “wavefront” on a single SIMD processing unit 438. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 438 or partially or fully in parallel on different SIMD units 438. A wavefront can be thought of as the largest collection of work-items that can be executed simultaneously on a single SIMD unit 438. Thus, if commands received from the processor 402 indicate that a particular program is to be parallelized to such a degree that the program cannot execute on a single SIMD unit 438 simultaneously, then that program is broken up into two or more wavefronts which are parallelized on two or more SIMD units 438 or serialized on the same SIMD unit 438 (or both parallelized and serialized as needed). A scheduler 436 is configured to perform operations related to scheduling various wavefronts on different compute units 432 and SIMD units 438.

The parallelism afforded by the compute units 432 is suitable for graphics related operations such as pixel value calculations, vertex transformations, and other graphics operations. Thus in some instances, a graphics pipeline 434, which accepts graphics processing commands from the processor 402, provides computation tasks to the compute units 432 for execution in parallel.

The compute units 432 are also used to perform computation tasks not related to graphics or not performed as part of the “normal” operation of a graphics pipeline 434 (e.g., custom operations performed to supplement processing performed for operation of the graphics pipeline 434). An application 426 or other software executing on the processor 402 transmits programs that define such computation tasks to the APD 416 for execution.

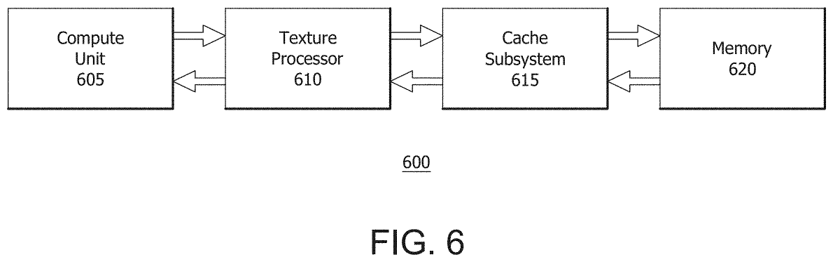

FIG. 6 is a high level block diagram of an example texture processor system 600 with a modified bilinear filter in accordance with certain implementations. The texture processor system 600 includes a compute unit 605 connected to or in communication with (collectively “connected to”) a texture processor 610, which in turn is connected to a cache system 615. The cache system 615 is connected to a memory 620. The compute unit 605 executes shader programs which control operations performed by the texture processor 610. Alternatively, shader functionality can be implemented partially or fully as fixed-function, non-programmable hardware external to the compute unit 605. The texture processor 610 performs texture sampling operations pursuant to instructions from the compute unit 605. The texture processor 610 reads texture data from the cache system 615 or the memory 620, as appropriate, and supplies modified texel inputs and weights into its bilinear filter to prevent smaller (finer LOD) values from leaking into the area of bigger (coarser LOD) values. The texture processor 610 returns filtering results based on the modified texel inputs and weights to the compute unit 605 for processing.

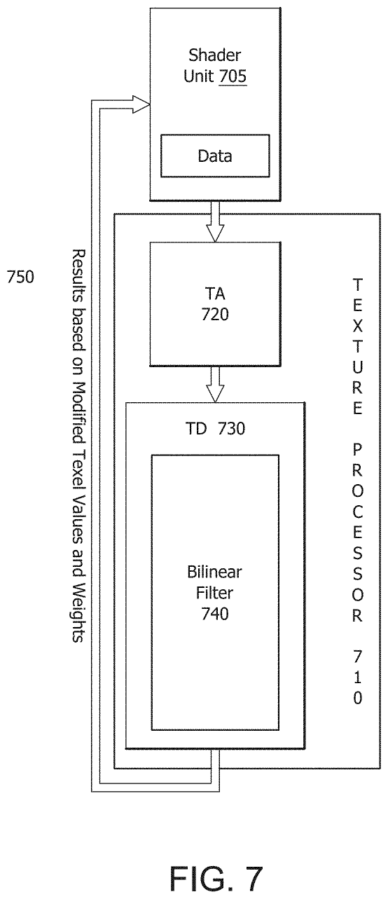

FIG. 7 is a more detailed block diagram of an example texture processor system 700 in accordance with certain implementations. The texture processor system 700 includes a shader unit or shader processor 705 connected to or in communication with (collectively “connected to”) a texture processor 710. The texture processor 710 includes a texture address (TA) unit 720 which is connected to to a texture data (TD) unit 730. The texture data unit 730 is a data filtering unit and includes at least a bilinear filter 740. The texture data unit 730 is connected to the shader unit 705 via a texture data return path 750.

At a top level, the shader unit 705 sends texture instructions to the texture address unit 720. The texture address unit 720 filters/processes the texture instruction to obtain the texture data including for example, the LOD map texel data. The texture data unit 730 generates modified texel inputs and weights from the texture data received from the texture address unit 720. The modified texel inputs and weights prevent smaller (finer LOD) values from leaking into the area of bigger (coarser LOD) values. The bilinear filter 740 receives and applies the weights to the modified texel inputs and generates texture data results, which are in turn sent to the shader unit 705.

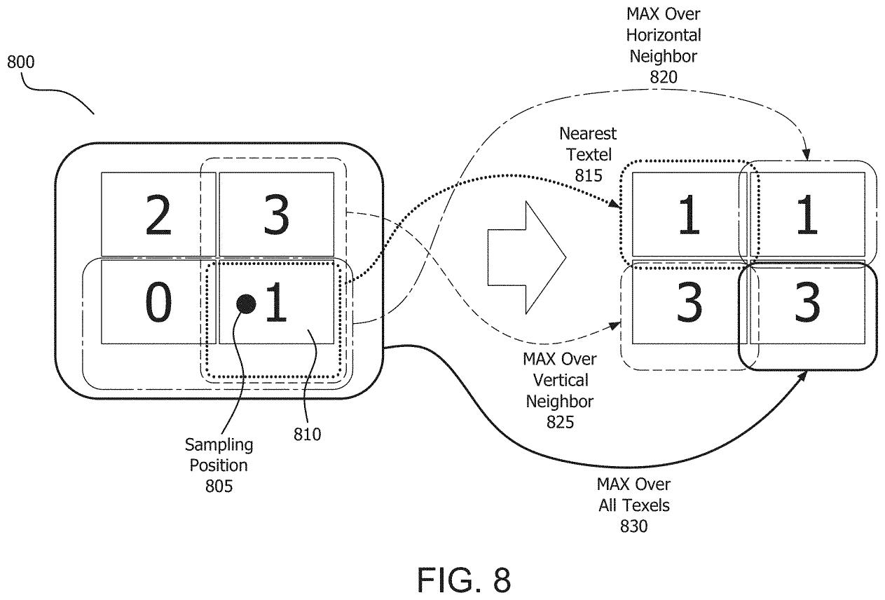

FIG. 8 is a diagram illustrating generation of modified texel inputs in accordance with certain implementations. Given a partial LOD map 800, a sample is taken from a sampling position 805 in a texel 810. Texel inputs to the bilinear filter are then modified by replacing original texels around the texel nearest the sampling position 805 with texels which have texel values that have at least the same or larger values than the original texels. This is generated by reviewing the original texels relative to the sampling position 805 with respect to different positions or arrangements. A texel position is first determined using Equation 1. A top texel position 815 (indicated as top left (TL) in the equations below) is replaced by a texel nearest to the sampling position 810 using, for example, Equation 2:

texel_id=(u_frac<0.5)?(v_frac<0.5?TL:BL):(v_frac<0.5?TR:BR); Eq. (1)

sample′[TL]=sample[texel_id]; Eq. (2)

Moreover, horizontal and vertical texel neighbors, 820 and 825, respectively, (indicated as top right (TR) and bottom right (BR) in the equations below) are replaced with texels having a maximum value along their respective axes. This can be determined, for example, using Equations 3 and 4:

sample′[TR]=max(sample[(texel_id==TL∥texel_id==TR)?TL:BL],

sample[(texel_id==TL∥texel_id==TR)?TR:BR]); Eq. (3)

sample′[BL]=max(sample[(texel_id==TL∥texel_id==BL)?TL:TR],

sample[(texel_id==TL∥texel_id==BL)?BL:BR]); Eq. (4)

Furthermore, a diagonal texel neighbor 830 is replaced with a texel which has the maximum value with respect to all texels in a given texel quad. This can be determined, for example, using Equation 5:

sample′[BR]=max(sample[TL],sample[TR],sample[BL],sample[BR]); Eq. (5)

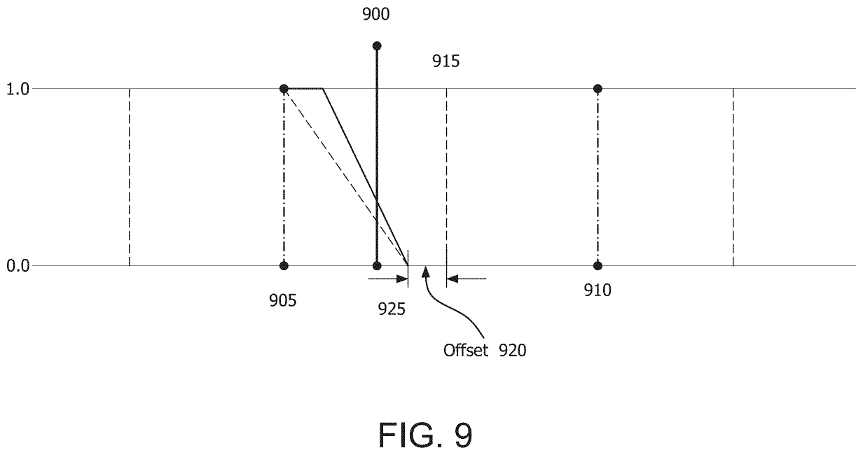

FIG. 9 is a diagram illustrating generation of U coordinate weights (weight_u) in accordance with certain implementations. Generation of V coordinate weights (weight_v) is similarly implemented. For a sampling position 900, a nearest texel with center at position 905 and a next nearest texel with center at position 910 are determined. For texels 905 and 910, a mid-point position 915 is determined that is equidistant from texel center positions 905 and 910. The mid-point position 915 is shifted towards texel center position 905 according to a specified offset 920 to obtain a position 925. For the sampling position 900, an absolute distance from sampling position 900 to position 925 is determined. This distance is scaled with a slope and clamped to [0 . . . 1] range to generate a bilinear weight weight_u for the sampling position 903. The weight_v is similarly generated. The bilinear filter applies the weights, weight_u and weight_v, to the modified texel inputs according to Equation 6, for example:

result=sample′[TL]*weight_u*weight_v+sample′[TR]*(1−weight_u)*weight_v+sample′[BL]*weight_u*(1−weight_v)+sample′[BR]*(1−weight_u)*(1−weight_v); Eq. (6)

The texel input modifications ensure that texels neighbor to the nearest texel are replaced with maximum texel values over the horizontal, vertical and all neighbors. This ensures that the filter result is the same or bigger (coarser LOD) than the nearest texel's value. This is illustrated in FIG. 3C, where the smaller texel value influence stops at the boundary of the texel with the bigger texel value.

For volume (3D) textures, the bilinear filter is extended to a third coordinate, w. In this implementation, there are two texel quads from two UV slices nearest to the sampling position along the w coordinate axis. Each texel quad generates a 2D bilinear filter result, for example, result0 and result1. Assuming result0 corresponds to the UV slice that is closest to the sampling position along the w axis, the final result is:

weight_w=clamp((abs(w frac−0.5)−offset_w*slope_w,0,1);

result=(result0<result1)?(result0*weight_w+result1*(1−weight_w):result0 Eq. (7)

This way finer result value leakage is prevented from leaking into the area of the coarser result value. This comes from the Equation 7, which ignores the weight and picks the nearest texel quad filtering result value if it is coarser (bigger) than a neighbor one. This way the influence of a texel quad with finer (lower) filtering result value is ignored for all of the volume corresponding to the coarser nearest texel quad.

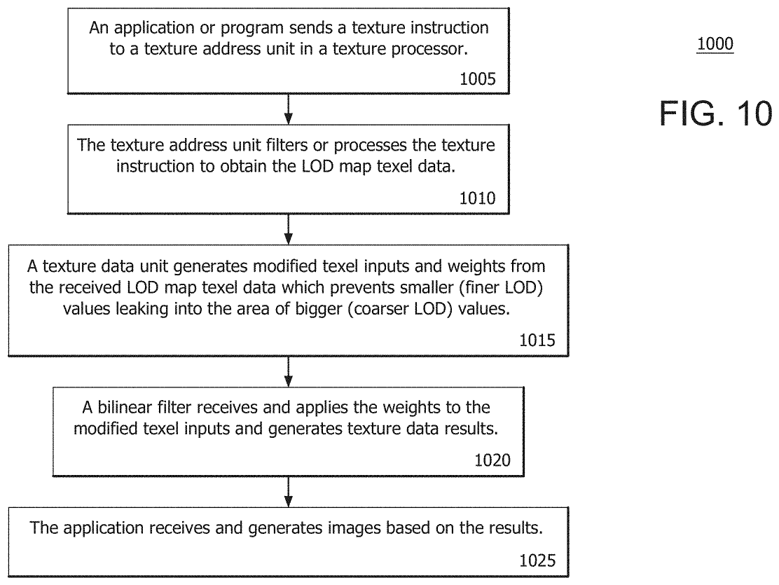

FIG. 10 is a flowchart 1000 for a method for preventing finer result value leakage into areas of coarser result values in accordance with certain implementations. An application or program, such as a shader unit, sends a texture instruction to a texture address unit in a texture processor (step 1005). The texture address unit filters or processes the texture instruction to obtain the LOD map texel data (step 1010). A texture data unit generates modified texel inputs and weights from the received LOD map texel data which prevents smaller (finer LOD) values leaking into the area of bigger (coarser LOD) values (step 1015). A bilinear filter receives and applies the weights to the modified texel inputs and generates texture data results (step 1020). The application receives and generates images based on the results (1025).

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for smooth level of detail (LOD) value filtering, the method comprising:
receiving, at a texture processor, a texture instruction;
processing, by a texture address unit, the texture instruction to obtain at least an LOD map texel data;
generating, by a texture data unit, modified texel inputs from the LOD map texel data;
generating, by the texture data unit, at least two weights in a texture space region; and
applying, by a bilinear filter, the at least two weights to the modified texel inputs,
wherein the modified texel inputs and weights prevent finer LOD values from leaking into an area of coarser LOD values.

2. The method of claim 1, wherein generating the modified texel inputs further includes:
replacing original texels around a texel nearest a sampling position with texels which have values that are same or larger than values of the original texels.

3. The method of claim 1, wherein generating the modified texel inputs further includes:
replacing original texels around a texel nearest a sampling position with texels which have maximum values with respect to a given texel arrangement.

4. The method of claim 1, wherein generating the modified texel inputs further includes:
replacing original texels around a texel nearest a sampling position with texels which have maximum values with respect to a horizontal axis, a vertical axis and all neighbors.

5. The method of claim 1, wherein generating the modified texel inputs further includes:
determining a position of a texel nearest a sample position;
replacing a top texel position, relative to a nearest texel, with the nearest texel;
replacing horizontal texel neighbor with a texel having a maximum value along a horizontal axis;
replacing vertical texel neighbor with a texel having a maximum value along a vertical axis; and
replacing a diagonal texel neighbor with a texel having a maximum value with respect to all texels in a given texel quad.

6. The method of claim 1, wherein generating the at least two weights further includes:
for each of a first weight and a second weight:
determining a center position of a texel nearest a sample position;
determining a center position of a texel next nearest to the sample position;
determining a mid-point between the center position of a nearest texel and the center position of a next nearest texel;
shifting the mid-point towards the center position of the nearest texel by a given offset;
determining a distance between a shifted position and the sampling position;
scaling the distance with a slope; and
generating a respective weight by clamping a scaled distance to a predetermined range.

7. The method of claim 1, wherein the method further comprises:
generating, by the texture data unit, sets of modified texel inputs and another weight for volume textures.

8. The method of claim 7, wherein the at least two weights correspond to a first coordinate and a second coordinate and the another weight corresponds to a third coordinate, the generating the another set includes:
taking at least two slices along the third coordinate nearest to a sampling position along the third coordinate, each slice being a plane in the first coordinate and the second coordinate and having a representative texel quad;
generating, by the texture data unit, a set of modified texel inputs for each texel quad; and
applying, by the filter, the third weight to each of the sets of modified texel inputs.

9. A system for smooth level of detail (LOD) value filtering, the system comprising:
a shader;
a cache;
a texture processor including at least a bilinear filter, the texture processor connected to the shader and the cache,
wherein the texture processor is configured to:
to receive a texture instruction;
obtain at least an LOD map texel data;
generate modified texel inputs from the LOD map texel data;
generate at least two weights in a texture space region; and
wherein the bilinear filter is configured to:
apply the at least two weights to the modified texel inputs, and
wherein the modified texel inputs and weights prevent finer LOD values from leaking into an area of coarser LOD values.

10. The system of claim 9, wherein the texture processor is configured to:
replace original texels around a texel nearest a sampling position with texels which have values that are same or larger than values of the original texels.

11. The system of claim 9, wherein the texture processor is configured to:
replace original texels around a texel nearest a sampling position with texels which have maximum values with respect to a given texel arrangement.

12. The system of claim 9, wherein the texture processor is configured to:
replace original texels around a texel nearest a sampling position with texels which have maximum values with respect to a horizontal axis, a vertical axis and all neighbors.

13. The system of claim 9, wherein the texture processor is configured to:
determine a position of a texel nearest a sample position;
replace a top texel position, relative to a nearest texel, with the nearest texel;
replace horizontal texel neighbor with a texel having a maximum value along a horizontal axis;
replace vertical texel neighbor with a texel having a maximum value along a vertical axis; and
replace a diagonal texel neighbor with a texel having a maximum value with respect to all texels in a given texel quad.

14. The system of claim 9, wherein the texture processor is configured to:
for each of a first weight and a second weight:
determine a center position of a texel nearest a sample position;
determine a center position of a texel next nearest to the sample position;
determine a mid-point between the center position of a nearest texel and the center position of a next nearest texel;
shift the mid-point towards the center position of the nearest texel by a given offset;
determine a distance between a shifted position and the sampling position;
scale the distance with a slope; and
generate a respective weight by clamping a scaled distance to a predetermined range.

15. The system of claim 9, wherein the texture processor is configured to:
generate sets of modified texel inputs and another weight for volume textures.

16. The system of claim 15, wherein the at least two weights correspond to a first coordinate and a second coordinate and the another weight corresponds to a third coordinate, and wherein:
the texture processor is configured to:
take at least two slices along the third coordinate nearest to a sampling position along the third coordinate, each slice being a plane in the first coordinate and the second coordinate and having a representative texel quad;
generate a set of modified texel inputs for each texel quad; and
the filter is configured to:
apply the third weight to each of the sets of modified texel inputs.

17. A texture processor comprising:
a texture address unit connected to a shader; and
a texture data unit connected to the texture address unit and the shader, the texture data unit including a filter.
wherein:
the texture address unit is configured to:
receive a texture instruction; and
process the texture instruction to obtain at least an LOD map texel data; and
the texture data unit is configured to:
generate modified texel inputs from the LOD map texel data;
generate at least two weights in a texture space region; and
the bilinear filter configured to:
apply, the at least two weights to the modified texel inputs,
wherein the modified texel inputs and weights prevent finer LOD values from leaking into an area of coarser LOD values.

18. The texture processor of claim 17, wherein the texture data unit is configured to:
replace original texels around a texel nearest a sampling position with texels which have values that are same or larger than values of the original texels.

19. The texture processor of claim 17, wherein the texture data unit is configured to:
replace original texels around a texel nearest a sampling position with texels which have maximum values with respect to a given texel arrangement.

20. The texture processor of claim 17, wherein the texture data unit is configured to:
replace original texels around a texel nearest a sampling position with texels which have maximum values with respect to a horizontal axis, a vertical axis and all neighbors.

21. The texture processor of claim 17, wherein the texture data unit is configured to:
determine a position of a texel nearest a sample position;
replace a top texel position, relative to a nearest texel, with the nearest texel;
replace horizontal texel neighbor with a texel having a maximum value along a horizontal axis;
replace vertical texel neighbor with a texel having a maximum value along a vertical axis; and
replace a diagonal texel neighbor with a texel having a maximum value with respect to all texels in a given texel quad.

22. The texture processor of claim 17, wherein the texture data unit is configured to:
for each of a first weight and a second weight:
determine a center position of a texel nearest a sample position;
determine a center position of a texel next nearest to the sample position;
determine a mid-point between the center position of a nearest texel and the center position of a next nearest texel;
shift the mid-point towards the center position of the nearest texel by a given offset;
determine a distance between a shifted position and the sampling position;
scale the distance with a slope; and
generate a respective weight by clamping a scaled distance to a predetermined range.

23. The texture processor of claim 17, wherein the texture data unit is configured to:
generate sets of modified texel inputs and another weight for volume textures.

24. The texture processor of claim 23, wherein the at least two weights correspond to a first coordinate and a second coordinate and the another weight corresponds to a third coordinate, wherein at least two slices are taken along the third coordinate nearest to a sampling position along the third coordinate, each slice being a plane in the first coordinate and the second coordinate and having a representative texel quad and wherein:
the texture data unit is configured to:
generate, by the texture data unit, a set of modified texel inputs for each texel quad; and
the bilinear filter is configured to:
apply the third weight to each of the sets of modified texel inputs.
